(19) United States
(12) Patent Application Publication
(10) Pub. No.: US 2018/0228175 A1
(43) Pub. Date: Aug. 16, 2018

(54) Processes for the Enzymatic Treatment of UHT Sterilized Milks to Reduce Cooked Flavor, Sulfur Odor, and Brown Color

(71) Applicant: fairlife, LLC, Chicago, IL (US)

(72) Inventors: Shakeel Ur-Rehman, Naperville, IL (US); Brandon Kopesky, Chicago, IL (US); Scott Backinoff, La Grange, IL (US); Tim Doelman, Glencoe, IL (US)

(21) Appl. No.: 15/893,762

(22) Filed: Feb. 12, 2018

Related U.S. Application Data
(60) Provisional application No. 62/458,610, filed on Feb. 14, 2017.

(51) Int. Cl. A23C 9/12; A23C 3/02

(52) U.S. Cl. CPC A23C 9/1206; A23C 3/02

(57) ABSTRACT

Disclosed are processes for reducing the cooked flavor, sulfur odor, and brown color of milk products that have been subjected to ultra-high temperature (UHT) sterilization via the use of lactose oxidase or glucose oxidase.

### REFERENCE TO RELATED APPLICATION

This application claims the benefit of U.S. Provisional Application Ser. No. 62/458,610, filed on Feb. 14, 2017, the disclosure of which is incorporated herein by reference in its entirety.

### BACKGROUND OF THE INVENTION

The present invention relates generally to processes for reducing off-taste and odor of milk products—such as cooked flavor, sulfur odor, and brown color—via enzymatic treatment.

### SUMMARY OF THE INVENTION

This summary is provided to introduce a selection of concepts in a simplified form that are further described herein. This summary is not intended to identify required or essential features of the claimed subject matter. Nor is this summary intended to be used to limit the scope of the claimed subject matter.

Processes for reducing certain off-tastes and odors in milk products are disclosed herein. In accordance with an embodiment of the present invention, a process to reduce cooked flavor, sulfur odor, and/or brown color of a finished milk product is provided, and in this embodiment, the process can comprise (i) contacting an unpasteurized milk product with an enzyme comprising lactose oxidase and/or glucose oxidase to form an enzymatically-treated milk product, (ii) subjecting the enzymatically-treated milk product to ultra-high temperature (UHT) sterilization to form a sterilized milk product, and (iii) cooling the sterilized milk product to a temperature of less than or equal to about 50° C. to form the finished milk product.

In another embodiment of the present invention, a process to reduce cooked flavor, sulfur odor, and/or brown color of a finished milk product is provided, and in this embodiment, the process can comprise (a) subjecting an unpasteurized milk product to ultra-high temperature (UHT) sterilization to form a sterilized milk product, and (b) contacting the sterilized milk product with an enzyme comprising lactose oxidase and/or glucose oxidase to form the finished milk product.

Unexpectedly, and beneficially, these processes can result in finished milk products with superior organoleptic properties.

Both the foregoing summary and the following detailed description provide examples and are explanatory only. Accordingly, the foregoing summary and the following detailed description should not be considered to be restrictive. Further, features or variations can be provided in addition to those set forth herein. For example, certain embodiments can be directed to various feature combinations and sub-combinations described in the detailed description.

### Definitions

To define more clearly the terms used herein, the following definitions are provided. Unless otherwise indicated, the following definitions are applicable to this disclosure. If a term is used in this disclosure but is not specifically defined herein, the definition from the IUPAC Compendium of Chemical Terminology, 2^{nd} Ed (1997), can be applied, as long as that definition does not conflict with any other disclosure or definition applied herein, or render indefinite or non-enabled any claim to which that definition can be applied. To the extent that any definition or usage provided by any document incorporated herein by reference conflicts with the definition or usage provided herein, the definition or usage provided herein controls.

Herein, features of the subject matter can be described such that, within particular aspects and/or embodiments, a combination of different features can be envisioned. For each and every aspect, and/or embodiment, and/or feature disclosed herein, all combinations that do not detrimentally affect the designs, processes, and/or methods described herein are contemplated with or without explicit description of the particular combination. Additionally, unless explicitly recited otherwise, any aspect, and/or embodiment, and/or feature disclosed herein can be combined to describe inventive features consistent with the present disclosure.

While compositions and processes are described herein in terms of “comprising” various components or steps, the compositions and processes also can “consist essentially of” or “consist of” the various components or steps, unless stated otherwise.

The terms “a,” “an,” and “the” are intended to include plural alternatives, e.g., at least one, unless otherwise specified. For instance, the disclosure of “an enzyme” is meant to encompass one, or mixtures or combinations of more than one, enzyme, unless otherwise specified.

The terms “contact product,” “contacting,” and the like, are used herein to describe compositions and methods wherein the components are contacted together in any order, in any manner, and for any length of time, unless otherwise specified. For example, the components can be contacted by blending or mixing. Further, unless otherwise specified, the contacting of any component can occur in the presence or absence of any other component of the compositions and methods described herein. Combining additional materials or components can be done by any suitable method. Further, the term “contact product” includes mixtures, blends, solutions, slurries, reaction products, and the like, or combinations thereof. Although “contact product” can, and often does, include reaction products, it is not required for the respective components to react with one another. Similarly, the term “contacting” is used herein to refer to materials which can be blended, mixed, slurried, dissolved, reacted, treated, or otherwise contacted or combined in some other manner. Hence, “contacting” two or more components can result in a mixture, a reaction product, a reaction mixture, etc.

Although any methods and materials similar or equivalent to those described herein can be used in the practice or testing of the invention, the typical methods and materials are herein described.

Several types of ranges are disclosed in the present invention. When a range of any type is disclosed or claimed, the intent is to disclose or claim individually each possible number that such a range could reasonably encompass, including end points of the range as well as any sub-ranges and combinations of sub-ranges encompassed therein. As a representative example, certain process steps can be performed in certain pH ranges in various embodiments of this invention. By a disclosure that the pH can be in a range from about 5.5 to about 8, the intent is to recite that the pH can be any pH within the range and, for example, can be equal to about 5.5, about 6, about 6.5, about 7, about 7.5, or about 8. Additionally, the pH can be within any range from about 5.5 to about 8 (for example, from about 5.5 to about 6.5), and this also includes any combination of ranges between about 5.5 and about 8 (for example, the pH can be in a range from about 5.5 to about 6, or from about 6.8 to about 7.8). Likewise, all other ranges disclosed herein should be interpreted in a manner similar to this example.

The term “about” means that amounts, sizes, formulations, parameters, and other quantities and characteristics are not and need not be exact, but may be approximate including being larger or smaller, as desired, reflecting tolerances, conversion factors, rounding off, measurement errors, and the like, and other factors known to those of skill in the art. In general, an amount, size, formulation, parameter or other quantity or characteristic is “about” or “approximate” whether or not expressly stated to be such. The term “about” also encompasses amounts that differ due to different equilibrium conditions for a composition resulting from a particular initial mixture. Whether or not modified by the term “about,” the claims include equivalents to the quantities. The term “about” can mean within 10% of the reported numerical value, preferably within 5% of the reported numerical value.

### DETAILED DESCRIPTION OF THE INVENTION

Processes for reducing undesired tastes, odors, and/or colors of milk products are disclosed and described herein. Such processes can be used to reduce, for example, an undesirable cooked flavor of a milk product, an undesirable sulfur odor of a milk product, and/or an undesirable brown color of a milk product. These processes can result in higher quality milk products with better organoleptic properties, and in turn, can lead to less waste and consumer complaints resulting from milk products that are deemed unacceptable due to undesirable flavor, odor, or color.

In one embodiment, a process to reduce cooked flavor, sulfur odor, and/or brown color of a finished milk product is provided, and in this embodiment, the process can comprise (or consist essentially of, or consist of) (i) contacting an unpasteurized milk product with an enzyme comprising lactose oxidase and/or glucose oxidase to form an enzymatically-treated milk product, (ii) subjecting the enzymatically-treated milk product to ultra-high temperature (UHT) sterilization to form a sterilized milk product, and (iii) cooling the sterilized milk product to a temperature of less than or equal to about 50° C. to form the finished milk product.

As would be recognized by those of skill in the art, a sterilized milk product also may be referred to as a pasteurized milk product, an unpasteurized milk product also may be referred to as a raw milk product, and UHT sterilization also may be referred to as UHT pasteurization. Moreover, processes consistent with embodiments of this invention, to reduce the undesired taste, odor, and/or color of a finished milk product, are applicable to any finished milk product that has been pasteurized or sterilized. Non-limiting examples of typical finished milk products can include whole milk, low-fat milk, skim milk, buttermilk, flavored milk, low lactose milk, high protein milk, lactose-free milk, ultra-filtered milk, micro-filtered milk, concentrated milk, evaporated milk, high protein, high calcium, and reduced sugar milk, and the like. Thus, consistent with some embodiments of this invention, the finished milk product does not include fermented products, such as yogurts and cheeses.

In another embodiment, a process to reduce cooked flavor, sulfur odor, and/or brown color of a finished milk product is provided, and in this embodiment, the process can comprise (or consist essentially of, or consist of) (a) subjecting an unpasteurized milk product to ultra-high temperature (UHT) sterilization to form a sterilized milk product, and (b) contacting the sterilized milk product with an enzyme comprising lactose oxidase and/or glucose oxidase to form the finished milk product.

Generally, the features of the processes (e.g., the type and characteristics of the finished milk product, the amount and type of enzyme used, the conditions of UHT sterilization, the conditions under which the enzyme and the respective milk product are contacted, among others) are independently described herein and these features can be combined in any combination to further describe the disclosed processes. Moreover, other process steps can be conducted before, during, and/or after any of the steps listed in the disclosed processes, unless stated otherwise. Additionally, resultant milk products (e.g., finished milk products, ready for consumption) produced in accordance with any of the disclosed processes are within the scope of this disclosure and are encompassed herein.

In an embodiment, the enzyme used in the processes disclosed herein can comprise lactose oxidase. Alternatively, in another embodiment, the enzyme used in the processes disclosed herein can comprise glucose oxidase. Yet, in another embodiment, the enzyme used in the processes disclosed herein can comprise lactose oxidase and glucose oxidase; thus, combinations of lactose oxidase and glucose oxidase (e.g., a mixture of lactose oxidase and glucose oxidase, sequential addition of lactose oxidase and glucose oxidase in any order, etc.) can be employed, if desired.

The sterilized milk product, the unpasteurized milk product, and the finished milk product independently can have a total solids content in a range from about 5 to about 15 wt. %, and the % solids can vary significantly depending upon the type of milk product (e.g., skim milk versus whole milk). Often, the sterilized milk product, the unpasteurized milk product, and the finished milk product independently can have a total solids content in a range from about 5 to about 12 wt. %; alternatively, from about 6 to about 14 wt. %; alternatively, from about 7 to about 13 wt. %; alternatively, from about 7 to about 11 wt. %; alternatively, from about 8 to about 15 wt. %; or alternatively, from about 8 to about 12 wt. %. Other appropriate % solids contents of the sterilized milk product, the unpasteurized milk product, and the finished milk product are readily apparent from this disclosure.

The contacting steps (step (i), step (b)) in the processes disclosed herein can be conducted at any suitable conditions, for instance, any conditions sufficient to reduce (or eliminate) one or more of the undesired cooked flavor, the undesired sulfur odor, the undesired brown color, or any combination thereof. For instance, the contacting steps can be conducted at a variety of temperatures and time periods. Generally, the contacting steps, independently, can be conducted at any temperature sufficient to reduce the undesired cooked flavor, sulfur odor, and/or brown color. In some illustrative and non-limiting embodiments, the contacting steps, independently, can be conducted at a temperature in a range from about 0° C. to about 65° C.; alternatively, from about 0° C. to about 38° C.; alternatively, from about 0° C. to about 15° C.; alternatively, from about 2° C. to about 52° C.; alternatively, from about 2° C. to about 38° C.; alternatively, from about 2° C. to about 32° C.; alternatively, from about 2° C. to about 18° C.; or alternatively, from about 2° C. to about 10° C. In these and other embodiments, these temperature ranges also are meant to encompass circumstances where the respective contacting step is conducted at a series of different temperatures, instead of at a single fixed temperature, falling within the respective ranges. Other appropriate temperature ranges at which the enzyme and the sterilized milk product or the unpasteurized milk product can be contacted are readily apparent from this disclosure.

The duration of the contacting steps (step (i), step (b)) is not limited to any particular period of time. Generally, however, the contacting steps are conducted for a period of time sufficient to reduce the undesired taste, odor, and/or color characteristics. Often, contacting time can range from as little as 5-15 minutes to as long as 48-72 hours, or more. The appropriate contacting time can depend upon, for example, the temperature, the enzyme concentration, the pH, the degree of mixing, and considerations for long term storage, among other variables. In some illustrative and non-limiting embodiments, the contacting step can be conducted for at least about 5 min, at least about 15 min, at least about 30 min, at least about 1 hr, at least about 3 hr, at least about 6 hr, and so forth. Assuming the milk product, after contacting, is not intended for long term storage, which could extend for weeks or months, typical ranges for the contacting time can include, but are not limited to, from about 5 min to about 48 hr, from about 15 min to about 48 hr, from about 15 min to about 12 hr, from about 30 min to about 48 hr, from about 30 min to about 24 hr, from about 30 min to about 15 hr, from about 30 min to about 8 hr, from about 1 hr to about 36 hr, from about 1 hr to about 18 hr, from about 1 hr to about 12 hr, from about 1 hr to about 8 hr, and the like. Other appropriate periods of time for which the enzyme and the sterilized milk product or unpasteurized milk product can be contacted are readily apparent from this disclosure.

Generally, the pH during the contacting step (step (i), step (b)) of the enzyme and the sterilized milk or the unpasteurized milk is not limited to any particular pH range. In one embodiment, for example, the pH can be in a range from about 3.5 to about 8.5, from about 4 to about 8.5, from about 4.5 to about 8.5, from about 5.5 to about 8.5, or from about 6.5 to about 8.5. In another embodiment, the pH can be in a range from about 3.5 to about 8, from about 4 to about 8, from about 5 to about 8, from about 5.5 to about 8, or from about 6 to about 8. In yet another embodiment, the contacting steps can be conducted a substantially neutral pH, for instance, a pH typically in a range from about 5.5 to about 8.5, from about 6 to about 8, or from about 6.5 to about 7.5. Other appropriate pH conditions under which the enzyme and the sterilized milk product or unpasteurized milk product can be contacted are readily apparent from this disclosure.

Likewise, the pH values of the starting milk product (the sterilized milk product or the unpasteurized milk product) and the resultant milk product (the finished milk product) are not limited to any particular pH range. Generally, the pH ranges for the sterilized milk product, the unpasteurized milk product, and the finished milk product encompasses the same pH ranges as that of the pH ranges during contacting step (i) and contacting step (b) described above. Nonetheless, in particular embodiments of this invention, the pH of the sterilized milk product, the unpasteurized milk product, and the finished milk product independently can be in a range from about 5 to about 8, from about 5 to about 7.5, or from about 5 to about 7. Other suitable ranges for the pH of the sterilized milk product, the unpasteurized milk product, and the finished milk product independently can include, but are not limited to, from about 5.2 to about 8, from about 5.2 to about 7.5, or from about 5.2 to about 7, from about 5.2 to about 6.8, from about 5.5 to about 7.5, from about 5.5 to about 7, from about 6 to about 8, from about 6 to about 7.5, from about 6.2 to about 8, or from about 6.2 to about 7.5. Other appropriate pH values for the sterilized milk product, the unpasteurized milk product, and the finished milk product are readily apparent from this disclosure.

The amount of reduction in pH resulting from the enzymatic treatment can depend upon the amount of lactose oxidase (or glucose oxidase) used and the amount of lactose (or glucose) present in the milk product that is treated. Typically, the pH drop is not as significant as that found in fermentation processes (where pH values can drop below 4.6), and in some cases, the pH can be substantially constant (within 0.2 pH units) when compared before and after enzymatic treatment. In some embodiments, the decrease in pH due to the enzymatic treatment can be less than or equal to about 1, less than or equal to about 0.7, less than or equal to about 0.5, less than or equal to about 0.35, or less than or equal to about 0.2. Thus, for a milk product prior to enzymatic treatment having a pH of 7 and a finished milk product having a pH of 6.5, the decrease in pH is equal to 0.5.

In one embodiment, the amount of lactose (in the milk product prior to enzymatic treatment) that is converted to lactobionic acid (in the milk product after enzymatic treatment) can range from about 10 to about 60 wt. %, while in another embodiment, the amount of lactose converted to lactobionic acid can range from about 15 to about 55 wt. %, and in yet another embodiment, the amount of lactose converted to lactobionic acid can range from about 20 to about 50 wt. %. This weight percentage is determined by the amount of lactose prior to enzymatic treatment and the amount remaining after enzymatic treatment. Optionally, a suitable amount of catalase enzyme also can be added with the lactose oxidase. These same ranges apply to the amount of glucose (in the milk product prior to enzymatic treatment) that is converted to gluconic acid (in the milk product after enzymatic treatment). The amount of lactobionic acid (or gluconic acid) in the finished milk product can vary depending upon the initial amount of lactose (or glucose) prior to enzymatic treatment. Typically, the amount of lactobionic acid (or gluconic acid) in the finished milk product is less than or equal to about 2 wt. %, based on the total weight of the finished milk product. Other representative and non-limiting ranges for the amount of lactobionic acid (or gluconic acid) in the finished milk product can include less than or equal to about 1.5 wt. %, from about 0.25 to about 1.5 wt. %, from about 0.5 to about 2 wt. %, from about 0.5 to about 1.5 wt. %, from about 1 to about 2 wt. %, or from about 1 to about 1.5 wt. %. Other appropriate ranges for the amount of lactose (or glucose) converted and the resultant amount of lactobionic acid (or gluconic acid) are readily apparent from this disclosure.

The concentration of the enzyme in the contacting step (step (i), step (b)) is not limited to any particular range. However, the amount of the enzyme used in the contacting step, based on a liter of the sterilized milk product or the unpasteurized milk product, generally falls within a range from about 0.05 to about 5 mL, from about 0.05 to about 3 mL, from about 0.1 to about 4 mL, from about 0.1 to about 3 mL, or from about 0.1 to about 2 mL. Other non-limiting ranges can include from about 0.05 to about 2 mL, from about 0.05 to about 1 mL, from about 0.1 to about 1 mL, from about 0.1 to about 0.75 mL, from about 0.1 to about 0.5 mL, from about 0.15 to about 1 mL, or from about 0.15 to about 0.75 mL enzyme, per liter of the respective milk product. Other appropriate ranges for the enzyme concentration, based on the amount of the respective milk product, are readily apparent from this disclosure. For instance, the amount of lactose oxidase (having an activity of 15 lactose peroxidase units per gram) added can range from about 0.5 to about 5 g, from about 1 to about 4 g, or from about 1.8 to about 2 g of lactose oxidase, per 100 g of the lactose present in the respective milk product. Generally, the glucose oxidase can have an activity of approximately 1000 glucose oxidase units per gram.

In this disclosure, ultra-high temperature (UHT) sterilization (also referred to in the art as UHT pasteurization) refers to the generally high temperature treatment of a milk product for a relatively short time period. UHT sterilization can be conducted at a variety of suitable temperature and time conditions, as would be recognized by those of skill in the art. Representative and non-limiting examples of UHT conditions include a temperature in a range from about 130° C. to about 150° C. for a time period of from about 1 to about 15 sec, a temperature in a range from about 130° C. to about 150° C. for a time period of from about 2 to about 4 sec, a temperature in a range from about 135° C. to about 145° C. for a time period of from about 1 to about 10 sec, or a temperature in a range from about 135° C. to about 145° C. for a time period of from about 2 to about 5 sec, and the like. Other appropriate UHT sterilization temperature and time conditions are readily apparent from this disclosure.

This invention is not limited by the method or equipment used for performing the UHT sterilization process. Any suitable UHT sterilization technique can be employed, such as indirect steam injection, direct steam injection, direct steam infusion, indirect heating, direct heating, a hybrid of direct and indirect heating, and the like. The sterilization process also can be a batch sterilization process, such as at 121° C. for 20-30 minutes, or an equivalent. Moreover, combinations of these techniques can be employed, if desired. Any suitable sterilization system can be used, such as filter sterilization by microfiltration or by ultraviolet irradiation, high pressure or by ohmic heating, cavitation or by ultra-sonification, and the like.

In some embodiments of this invention, the processes to reduce the undesired taste, odor, and/or color characteristics of a finished milk product can include a step of cooling after the UHT sterilization has been performed. For instance, one such process can comprise subjecting an unpasteurized milk product to ultra-high temperature (UHT) sterilization to form a sterilized milk product, cooling the sterilized milk product to any suitable temperature, and contacting the sterilized milk product with an enzyme comprising lactose oxidase and/or glucose oxidase. Often, the sterilized milk product can be cooled to a temperature of less than or equal to about 50° C., less than or equal to about 45° C., less than or equal to about 40° C., or less than or equal to about 35° C. In other embodiments, the respective milk product can be cooled after UHT sterilization to a temperature in a range from about 5° C. to about 50° C., in a range from about 5° C. to about 40° C., in a range from about 8° C. to about 45° C., in a range from about 10° C. to about 45° C., in a range from about 15° C. to about 40° C., or in a range from about 20° C. to about 40° C., and the like. Other appropriate cooling temperatures are readily apparent from this disclosure.

In some embodiments of this invention, the processes to reduce the undesired taste, odor, and/or color characteristics of a finished milk product can further comprise a step of packaging the finished milk product in any suitable container and under any suitable conditions. As an example, a process can comprise (i) contacting an unpasteurized milk product with an enzyme comprising lactose oxidase and/or glucose oxidase (under suitable conditions) to form an enzymatically-treated milk product, (ii) subjecting the enzymatically-treated milk product to ultra-high temperature (UHT) sterilization to form a sterilized milk product, (iii) cooling the sterilized milk product to a temperature of less than or equal to about 50° C. to form the finished milk product, and (iv) packaging the finished milk product under aseptic conditions (or non-aseptic conditions) in a container. As another example, a process can comprise (a) subjecting an unpasteurized milk product to ultra-high temperature (UHT) sterilization to form a sterilized milk product, (b) contacting the sterilized milk product with an enzyme comprising lactose oxidase and/or glucose oxidase (under suitable conditions) to form the finished milk product, and (c) packaging the finished milk product under aseptic conditions (or non-aseptic conditions) in a container.

Any suitable container can be used, such as might be used for the distribution and/or sale of milk products in a retail outlet. Illustrative and non-limiting examples of typical containers include a cup, a bottle, a bag, or a pouch, and the like. The container can be made from any suitable material, such as glass, metal, plastics, and the like, as well as combinations thereof.

These finished milk products, advantageously, can be shelf-stable without refrigeration under a variety of temperature and time conditions, as would be recognized by those of skill in the art. Finished milk products encompassed herein can be shelf-stable at a temperature in a range from about 0° C. to about 40° C. for a time period of from about 2 to about 365 days, shelf-stable at a temperature in a range from about 0° C. to about 40° C. for a time period of from about 5 to about 180 days, shelf-stable at a temperature in a range from about 5° C. to about 25° C. for a time period of from about 2 to about 365 days, shelf-stable at a temperature in a range from about 5° C. to about 25° C. for a time period of from about 5 to about 180 days, shelf-stable at a temperature of from about 10° C. to about 25° C. for a time period of from about 2 to about 365 days, shelf-stable at a temperature in a range from about 10° C. to about 25° C. for a time period of from about 5 to about 180 days, or shelf-stable at a temperature in a range from about 10° C. to about 35° C. for a time period of from about 2 to about 180 days, and the like. Other appropriate shelf-stable temperature and time conditions are readily apparent from this disclosure.

Any suitable vessel and conditions can be used to contact the enzyme with the respective milk product, and such can be accomplished using a batch process or a continuous process. As an example, a process consistent with embodiments of this invention can comprise (i) contacting an unpasteurized milk product with an enzyme comprising lactose oxidase and/or glucose oxidase to form an enzymatically-treated milk product, (ii) subjecting the enzymatically-treated milk product to ultra-high temperature (UHT) sterilization to form a sterilized milk product, and (iii) cooling the sterilized milk product to a temperature of less than or equal to about 50° C. to form the finished milk product. In this process, the enzyme can be contacted with the unpasteurized milk product in a suitable vessel (e.g., a tank, a silo, etc.) under atmospheric pressure, optionally mixed to ensure sufficient distribution of the enzyme within the unpasteurized milk product, and under sufficient time and temperature to allow the enzymatic reaction to occur, in order to form a batch of enzymatically-treated milk product, which can then be subjected to UHT sterilization. As another example, a process consistent with embodiments of this invention can comprise (a) subjecting an unpasteurized milk product to ultra-high temperature (UHT) sterilization to form a sterilized milk product, and (b) contacting the sterilized milk product with an enzyme comprising lactose oxidase and/or glucose oxidase to form the finished milk product. In this process, the enzyme can be contacted with the UHT sterilized milk product continuously in a pipe or other suitable vessel under slight pressure (e.g., 5-50 psig), optionally mixed to ensure sufficient distribution of the enzyme within the sterilized milk product, and the finished milk product can be transferred to a storage tank or filled into containers for retail distribution and sale. In this process, the enzymatic reaction may be completed after the finished milk product has been filled into containers. Representative systems that can be used for this continuous addition of enzyme to the UHT treated milk product can include tetra aldose systems and tetra flexidose systems. Other appropriate methods, systems, and apparatus for contacting the enzyme and the respective milk product are readily apparent from this disclosure.

Beneficially, and unexpectedly, the processes disclosed herein are very effective at reducing undesirable taste, odor, and/or color characteristics of a milk product. In particular embodiments of this invention, the respective finished milk products produced by the processes disclosed herein can have less cooked flavor, less sulfur odor, and/or less brown color than that of (or as compared to that of) a respective finished milk product obtained under the same processing conditions, but without the addition of the enzymes described herein. Thus, in one embodiment, the finished milk product can have less cooked flavor, while in another embodiment, the finished milk product can have less sulfur odor. In another embodiment, the finished milk product can have less brown color. In yet another embodiment, the finished milk product can have less cooked flavor and less sulfur odor, or less cooked flavor and less brown color, or less sulfur odor and less brown color. In still another embodiment, the finished milk product can have less cooked flavor, less sulfur odor, and less brown color. The same processing conditions means that all components and processing parameters (e.g., UHT conditions) used to prepare the finished milk product are held constant. Hence, the only difference is the use of the enzyme versus standard milk production (i.e., without the enzyme).

Moreover, also beneficially and unexpectedly, the processes disclosed herein are very effective at reducing the amount of sulfur-containing compounds, for example, below the human sensory threshold levels for off-taste and odor. While not being limited thereto, an exemplary sulfur-containing compound often associated with off-taste and odor is hydrogen sulfide (H₂S), and its concentration can be reduced to below its sensory threshold of about 10 ppb (parts per billion, weight basis).

### Examples

The invention is further illustrated by the following examples, which are not to be construed in any way as imposing limitations to the scope of this invention. Various other aspects, embodiments, modifications, and equivalents thereof which, after reading the description herein, can suggest themselves to one of ordinary skill in the art without departing from the spirit of the present invention or the scope of the appended claims.

Table I summarizes certain characteristics of three finished milk products. Generally, the three finished milk products had equivalent pH, % solids, % fat, and % protein characteristics (the lactose content was in the 2.5-3.0 wt. % range for Examples 1-3). Example 1 was produced by subjecting an unpasteurized milk product to UHT sterilization, via direct steam injection, at temperature of 138-145° C. for 2-6 seconds. Example 2 was produced by first mixing the unpasteurized milk product with 0.4 mL of lactose oxidase (having an activity of 15 lactose peroxidase units per gram) per liter of the unpasteurized milk product, and storing the resultant mixture at 3° C. for 12 hours, prior to UHT sterilization under the same conditions as that of Example 1. Example 3 was produced by first subjecting the unpasteurized milk product to UHT sterilization under the same conditions as that of Example 1, then mixing the sterilized milk product with 0.22 mL of lactose oxidase per liter of the sterilized milk product, and storing the resultant mixture at 3° C. for 12 hours.

The finished milk products of Examples 1-3 were evaluated for organoleptic properties by four individuals, all of whom agreed that Example 1 had the most offensive cooked flavor and sulfur odor. Unexpectedly, Examples 2-3 had significantly improved organoleptic properties in comparison to Example 1. Two individuals concluded that Example 2 had the least cooked flavor and sulfur odor. The other two individuals concluded that Example 3 had the least cooked flavor, but could not distinguish the least smell/odor between Example 2 and Example 3.

TABLE I
Examples 1-3.

| | | Solids | Fat | Protein |
|---|---|---|---|---|
| | pH | Wt. % | Wt. % | Wt. % |
| Example 1 | 6.83 | 9.85 | 1.74 | 5.05 |
| Example 2 | 6.79 | 8.98 | 1.68 | 4.52 |
| Example 3 | 6.76 | 9.87 | 1.77 | 4.99 |

We claim:

1. A process to reduce cooked flavor, sulfur odor, and/or brown color of a finished milk product, the process comprising:
(i) contacting an unpasteurized milk product with an enzyme comprising lactose oxidase and/or glucose oxidase to form an enzymatically-treated milk product;
(ii) subjecting the enzymatically-treated milk product to ultra-high temperature (UHT) sterilization to form a sterilized milk product; and
(iii) cooling the sterilized milk product to a temperature of less than or equal to about 50° C. to form the finished milk product.

2. The process of claim 1, wherein the enzyme comprises lactose oxidase.

3. The process of claim 2, wherein the finished milk product contains less than or equal to about 1.5 wt. % of lactobionic acid.

4. The process of claim 1, wherein the unpasteurized milk product, the sterilized milk product, and the finished milk product independently have a total solids content in a range from about 5 to about 15 wt. %.

5. The process of claim 1, wherein the UHT sterilization is conducted at a temperature in a range from about 135° C. to about 145° C. for a time period in a range from about 1 to about 10 sec.

6. The process of claim 1, wherein the amount of the enzyme in step (i) is in a range from about 0.1 to about 3 mL per liter of the unpasteurized milk product.

7. The process of claim 1, wherein step (i) is conducted at a temperature in a range from about 2° C. to about 38° C. for a time period of at least 15 minutes.

8. The process of claim 1, wherein the unpasteurized milk product, the sterilized milk product, and the finished milk product independently have a pH in a range from about 5.2 to about 8.

9. The process of claim 1, wherein a difference in pH between the unpasteurized milk product and the finished milk product is less than or equal to about 0.7.

10. The process of claim 1, wherein the finished milk product has less cooked flavor, sulfur odor, and/or brown color than that of an otherwise identical milk product obtained without using the enzyme, under the same processing conditions.

11. The process of claim 1, wherein the finished milk product is shelf-stable at a temperature in a range from about 10° C. to about 25° C. for a time period in a range from about 2 to about 365 days.

12. A finished milk product prepared by the process of claim 1.

13. A process to reduce cooked flavor, sulfur odor, and/or brown color of a finished milk product, the process comprising:
(a) subjecting an unpasteurized milk product to ultra-high temperature (UHT) sterilization to form a sterilized milk product; and
(b) contacting the sterilized milk product with an enzyme comprising lactose oxidase and/or glucose oxidase to form the finished milk product.

14. The process of claim 13, wherein the enzyme comprises glucose oxidase.

15. The process of claim 13, wherein:
the unpasteurized milk product, the sterilized milk product, and the finished milk product independently have a pH in a range from about 5.2 to about 8; and
the unpasteurized milk product, the sterilized milk product, and the finished milk product independently have a total solids content in a range from about 5 to about 15 wt. %.

16. The process of claim 13, wherein step (b) is conducted at a temperature and for a time period sufficient to reduce cooked flavor, sulfur odor, and/or brown color.

17. The process of claim 13, wherein:
a difference in pH between the sterilized milk product and the finished milk product is less than or equal to about 0.7; and
the UHT sterilization is conducted at a temperature in a range from about 135° C. to about 145° C. for a time period in a range from about 1 to about 10 sec.

18. The process of claim 13, wherein:
the process further comprises a step of cooling the sterilized milk product to a temperature of less than or equal to about 40° C. after UHT sterilization; and
the process reduces an amount of sulfur-containing compounds below the human sensory threshold levels for off-taste and odor.

19. The process of claim 13, wherein the finished milk product is shelf-stable at a temperature in a range from about 10° C. to about 25° C. for a time period in a range from about 2 to about 365 days.

20. A finished milk product prepared by the process of claim 13.
